(19) United States
(12) Patent Application Publication
(10) Pub. No.: US 2026/0358142 A1
(43) Pub. Date: Nov. 12, 2026

(54) HIGH-PRECISION ANGULAR OR LINEAR NON-CONTACT MAGNETIC POSTIION SENSOR

(71) Applicant: Absolute Magnetics AG, Winterthur (CH)

(72) Inventors: Richard Arlot, Bonnevent-Velloreille (FR); Cornel Frigoli, Winterthur (CH); Adrian Alfred Baumgartner, Port (CH)

(21) Appl. No.: 19/129,911

(22) PCT Filed: Sep. 26, 2023
(86) PCT No.: PCT/EP2023/076591

§ 371 Date: May 14, 2025

(30) Foreign Application Priority Data
Nov. 22, 2022 (FR) FR2212135

(51) Int. Cl. G01D 5/14; G01B 7/00; G01B 7/30

(52) U.S. Cl. CPC G01D 5/145; G01B 7/003; G01B 7/30

(57) ABSTRACT

An angular or linear non-contact magnetic position sensor includes a permanent magnet generating a magnetic field that varies non-linearly and at least a first pair of probes associated with the permanent magnet, each probe being able to measure at least two field components at the same point. A processing circuit is connected to the first pair and is configured to exploit at least some of the measurements furnished by the first pair of probes and to deliver a position signal representative of the absolute position of the permanent magnet.

### CROSS-REFERENCE TO RELATED APPLICATIONS

This application is a national phase entry under 35 U.S.C. § 371 of International Patent Application PCT/EP2023/076591, filed Sep. 26, 2023, designating the United States of America and published as International Patent Publication WO 2024/110102 A1 on May 30, 2024, which claims the benefit under Article 8 of the Patent Cooperation Treaty of French Patent Application Serial No. FR2212135, filed Nov. 22, 2022.

### TECHNICAL FIELD

The present disclosure relates to the field of non-contact, magnetic and/or electromagnetic position sensors for the precise measurement of an absolute angular or linear position. Such sensors make it possible to detect an angular position or a linear displacement with high precision on the order of 0.1% of the total stroke, or <0.5° for a detection carried out on a complete revolution. Such systems, which can be robust to disturbance and highly accurate, are used, in particular, in the automotive and robotics industries.

### BACKGROUND

In the state of the art, European Patent Application No. EP1083406 describes a rotary sensor made up of a ring magnet and two magneto-sensitive sensing elements measuring the radial component of the field generated by the diametrically magnetized ring magnet. Placed in quadrature, these two magneto-sensitive elements generate two sinusoidal signals that enable the angular position of the rotating magnet to be detected by implementing the arc tangent function (Atan) of these two signals.

The disadvantage of this solution is its sensitivity to the placement of magneto-sensitive sensing elements to calculate a precise angular value. This solution is also sensitive to any external field. Indeed, any stray field with a component measurable by at least one of the two magneto-sensitive elements will induce a significant non-linearity error.

Also known is U.S. Pat. No. 7,741,839, which presents the principle of a rotary sensor comprising a ring magnet and two magneto-sensitive sensing elements measuring two quadrature components of the field generated by the ring magnet at the same point. These two elements generate two sinusoidal signals that again enable the angular position of the rotating magnet to be detected by implementing the Atan function of these two signals.

The accuracy of the detected signal is unsatisfactory, limited by widely differing signal amplitudes, leading to erroneous angular position calculations. This solution is also sensitive to any external field.

U.S. Pat. No. 7,030,608 describes some configurations that achieve equality between field components, but the impact is generally very limited and requires a large footprint. What is more, the problem of sensitivity to any external field is not solved, so this solution can only be considered highly inadequate for many applications.

To improve accuracy, French Patent No. FR2893410 proposes applying a compensation coefficient (gain) to the ratio of signals delivered by magneto-sensitive sensing elements located at the same point, equal to the ratio of the maximum amplitudes of the measured quadrature field components. This improves signal non-linearity, but the configuration remains limited to the case of a diametrically magnetized ring magnet.

European Patent No. EP1989505 describes a linear or rotary transducer featuring a magnet whose magnetization is linearly variable. Again, by applying a proportionality factor (gain), it is possible to determine the magnet's linear or angular displacement relative to the probe. Here again, however, precision is still insufficient, particularly in cases where the magnetization harmonics of the magnet are significant, or if the magnet contains inhomogeneities.

French Patent No. FR2965347 reports a case-by-case definition of the gain value, via numerous tests or calculations, to define a gain value different from the simple ratio of the maximum amplitudes of the components. This solution improves measurement accuracy, but remains very complicated to set up (test bench, simulations) and is limited to certain configurations.

The disadvantage of the latter solutions is their sensitivity to any external field.

French Patent No. FR2923903 describes an angular or linear sensor comprising a magnet with a direction of magnetization varying linearly with displacement, using two sets of probes placed in quadrature, each probe comprising a pair of magneto-sensitive sensing elements measuring quadrature field components. By combining these different field components to obtain two signals of equal quadrature intensity, it is possible to obtain an angular measurement that is insensitive to the external field under certain conditions. However, the angular accuracy of the sensor remains modest. The same principle applies to a linear transducer.

International Patent Application No. WO2009/101270 extends the principle described above and introduces a third and fourth set of magneto-sensitive sensing elements, “judiciously” offset from the first and second sets, and positioned therebetween identically to the first and second sets. By combining the signals from these 4 sets of magneto-sensitive sensing elements, it is possible to obtain an angular measurement that is insensitive to the external field under certain conditions, and to improve the accuracy (at least over a mechanical half-turn, that is, 180°) of the sensor by correcting the magnetization error linked to the magnet geometry (in particular, by compensating for magnetization harmonic 3). Given the number of elements involved (4 separate probes), this solution remains highly sensitive to probe positioning errors, and is still too imprecise, with a non-linearity of +/−0.1% over the 180° angular range, that is, at best an accuracy of +/−0.18° over this angular range. It is still too imprecise to be applied to certain automotive and robotics applications.

European Patent No. EP2711663 describes a sensor with two tracks and at least two probes, enabling very high angular accuracy by combining global detection from a first track and finer measurement from a second multipolar track. This solution does, however, require a high degree of overall detection accuracy, possibly through the use of additional probes (4 in total) on this sensor. The disadvantage of this solution is its sensitivity to the external field, and its susceptibility to errors in the positioning of the probes and the two magnetic tracks.

Also known in the state of the art is French Patent No. FR3118804 providing a simple angular or linear displacement measurement device using (at least) one magneto-sensitive sensing element capable of measuring at least two field components and a magnetized magnet with a magnetization profile including a combination of at least two periodic contributions enabling simultaneous calculation of a global position in the turn (or multi-turn) and a more precise local position of the displacement value.

A disadvantage of some of the solutions of the state of the art is their sensitivity to an external magnetic field.

It is always possible to shield the transducer, but this adds parts and significantly increases manufacturing costs, as well as the transducer's overall dimensions.

### BRIEF SUMMARY

The present disclosure proposes to solve, at least in part, the above-mentioned problems by taking advantage of the principles disclosed in French Patent FR3118804. In particular, the present disclosure facilitates the calculation of global and local positions. In particular, the present disclosure makes it easy to achieve accurate angular (or linear) position measurement, and can be configured to be insensitive to external fields.

In order to achieve this aim, the object of the present disclosure proposes an angular or linear non-contact magnetic position sensor, comprising:
a permanent magnet generating a magnetic field that varies non-linearly in the movement direction, the variation comprising, in the various field components, a combination of at least one first quasi-periodic signal, referred to as the “carried signal,” and at least one second quasi-periodic signal, referred to as the “carrier signal,” the first and second signals being different from one another,
at least one first pair of probes comprising a first main probe and a first secondary probe, the first pair being associated with the permanent magnet and each probe being capable of measuring at least two field components at a single point; and
a processing circuit connected to the probes and configured to exploit at least some of the measurements provided by the probes and to deliver a position signal representative of the absolute position of the permanent magnet.

According to the present disclosure, the two probes of the first pair of probes are positioned relative to one another to enable a first quasi-periodic signal representative of a global position and a second quasi-periodic signal representative of a local position to be isolated by differential combination of field component measurements.

According to other advantageous non-limiting features of the present disclosure, taken alone or according to any technically feasible combination:
the magnetic position sensor comprises a second pair of probes comprising a second main probe and a second secondary probe, the second pair of probes being associated with the permanent magnet and each probe of the second pair of probes being capable of measuring at least two field components at the same point, the two pairs of probes being positioned relative to one another so as to obtain quadrature matching of the signals obtained by differential combination;
the processing circuit establishes:
   the measurement of the sensor's global position by combining the field components according to the formula: Atan2 ((Br1+Bt3)+(Br2+Bt4); Gain*((Br3−Bt1)+(Br4−Bt2))) or
   the measurement of the sensor's local position by combining the field components according to the formula: Atan2 ((Br3−Bt1)−(Br4−Bt2); Gain*(Bz1−Bz2)),
      wherein Bri, Bti and Bzi respectively represent the radial, tangential and axial field measured by a probe of index i and wherein Gain is a quantity chosen so as to minimize the angular error calculated on the excursion of the sensor;
the processing circuit establishes the measurement of the local position of the sensor by combining the field components according to the formula: Atan2 ((Bz3−Bt1)−(Bz4−Bt2); Gain*((Bz1+Bt3)−(Bz2+Bt4))), wherein Bri, Bti and Bzi respectively represent the radial, tangential and axial field measured by a probe of index i and wherein Gain is a quantity chosen so as to minimize the angular error calculated on the excursion of the sensor;
the processing circuit establishes the global position measurement and/or local position measurement on different faces of the permanent magnet simultaneously;
the permanent magnet is a multipole magnet or a magnet assembly or an equivalent machined magnet.
the permanent magnet consists of a set of current loops;
the permanent magnet consists of all or part of the rotor of an electric motor, generator, actuator, gear reducer, coupler, gearbox or oscillator;
each probe comprises a plurality of magneto-sensitive elements selected from the list consisting of a Hall probe, a magnetoresistive element, an eddy-current element and a detection coil;
the permanent magnet has the shape of a disk, ring or cylinder, with the probes of the at least one pair of probes arranged around the periphery of the magnet;
the probes of the at least one pair of probes are separated by a first angular value corresponding to a half-period of the carried signal;
the probes of the first pair of probes and the probes of the second pair of probes are respectively separated from one another by a second angular value substantially equal to a quarter period of the carrier signal;
the first angular value and/or the second angular value is adjustable;
the processing circuit is configured to use an angular compensation factor to correct the calculated angular values;
the correction of calculated angular values is based on trigonometric functions;
the processing circuit is configured to combine analog and digital detection of the field components.

According to another aspect, the present disclosure proposes to use a non-contact magnetic position sensor as defined above for measuring additional values on a complex system, including force, torque, acceleration, braking, phase shift, overall speed, movement direction, distance, number of revolutions, inertia, imbalance, vibration, noise, harmonic content, temperature, pressure, electrical current, electrical voltage, electrical current, frequency, information encoding.

### BRIEF DESCRIPTION OF THE DRAWINGS

Other features and advantages of the present disclosure will emerge from the following detailed description of the present disclosure with reference to the appended figures, in which:

FIG. 1 shows a rotary encoder structure in a configuration conforming to the present disclosure;

FIG. 2 shows the evolution curve of the field components measured by a quasi-point probe of a sensor conforming to the present disclosure;

FIG. 3 shows the evolution curve of the radial field components measured by a first pair of probes phase-shifted by a first selected angular value, and the additive combination of these measurements;

FIG. 4 shows the evolution curve of the radial field components measured by the two pairs of probes arranged relative to one another in a configuration conforming to the present disclosure, with a view to calculating the global angular position;

FIG. 5 shows the evolution curve of the global angular value obtained by combining the radial component measured by four probes arranged relative to one another in a configuration conforming to the present disclosure;

FIGS. 6 and 7 show, respectively, the combinations of tangential and axial components of the field, obtained by combining the measurements provided by four probes arranged relative to one another in a configuration conforming to the present disclosure;

FIG. 8 shows the evolution curve of the radial field components measured by the two pairs of probes arranged relative to one another in a configuration conforming to the present disclosure, with a view to calculating the local angular position;

FIG. 9 shows the evolution curve of the local angular value obtained by combining the radial component measured by four probes arranged relative to one another in a configuration conforming to the present disclosure;

FIG. 10 shows the evolution curves of the field components measured by the two pairs of probes arranged relative to one another in a configuration conforming to the present disclosure, the measurements being combined with one another to be less sensitive to an external field in the calculation of the global angular position;

FIG. 11 shows the result of the angular position calculation provided by a sensor conforming to the present disclosure implementing the combinations of FIG. 10;

FIG. 12 shows the evolution curves of the field components measured by the two pairs of probes arranged relative to one another in a configuration conforming to the present disclosure, the measurements being combined with one another to be less sensitive to an external field in the calculation of the local angular position;

FIG. 13 shows the result of the angular position calculation provided by a sensor conforming to the present disclosure implementing the combinations of FIG. 12;

FIG. 14 shows the evolution curves of the field components measured by the two pairs of probes arranged relative to one another in a configuration conforming to the present disclosure, the measurements being combined with one another according to an alternative combination to that shown in FIG. 12;

FIG. 15 shows the result of the angular position calculation provided by a sensor conforming to the present disclosure implementing the combinations of FIG. 14;

FIGS. 16A, 16B, 17A, 17B, 18A, and 18B show the impact of an external magnetic field on angular errors;

FIG. 19 shows a sensor C according to the present disclosure in a linear configuration;

FIGS. 20 and 21 show the result of the angular position calculation provided by a sensor conforming to the present disclosure operating in a degraded mode with only a pair of probes;

FIG. 22 shows a rotary encoder structure in another configuration in accordance with the present disclosure.

### DETAILED DESCRIPTION

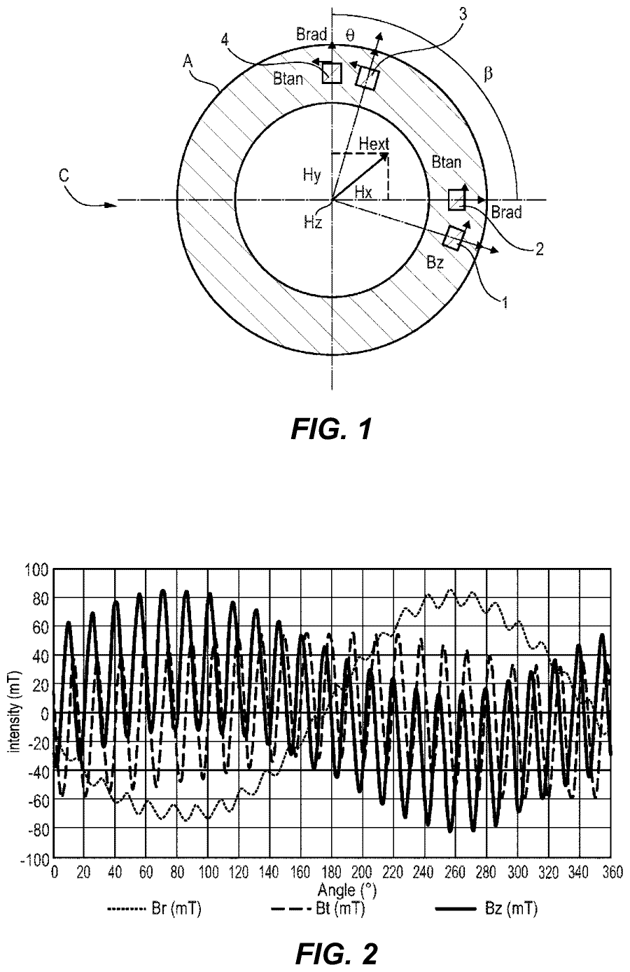

FIG. 1 shows the structure of a magnetic position sensor C in one embodiment. The magnetic flux generated by a disk-shaped permanent magnet A is collected at its periphery by at least four sets of sensing elements 1-4 (or magneto-sensors) or probes located radially or axially, without contact with the magnet. The permanent magnet can take any shape other than the disk shape of the magnet A shown in FIG. 1, in particular, a ring or cylinder shape.

Each set of sensing elements measures at least two components of magnetic induction at the same point, if necessary, via flux collectors defining an air gap, wherein the sensing elements 1-4 are placed. The magneto-sensitive elements can include, for example, Hall probes, magneto-resistive elements, eddy current elements and detection coils. As is well known, each set of magneto-sensitive elements can be integrated into a housing to form a magnetic probe, capable of detecting two or three field components. For simplicity of expression, in the remainder of this description a “probe” will refer to a set of magneto-sensitive elements capable of detecting two or three field components at almost any given moment. However, this designation in no way limits the implementation of the principles of the present disclosure, which may involve placing several sets of magneto-sensitive elements in the same housing to detect field components at a plurality of points.

The magnetic position sensor C shown in FIG. 1 therefore has four probes 1-4, comprising a first main probe 1 and a second main probe 2, on the one hand, and a first secondary probe 3 and a second secondary probe 4, on the other hand. The first main probe 1 and the second main probe 2 form a first pair of probes 1, 2, which are angularly out of phase with one another by a first separation angle theta (Θ). The first secondary probe 3 and the second secondary probe 4 form a second pair of probes 3, 4 angularly out of phase with one another by the first separation angle theta (Θ). The first pair of probes 1, 2 and the second pair of probes 3, 4 are angularly out of phase with one another by a second separation angle beta (β).

In the next section of this description, the advantages of such a configuration are discussed.

The permanent magnet A may be a multipole magnet or a magnet assembly, or an equivalent machined magnet. This magnet may consist of all or part of the rotor of an electric motor, generator, actuator, gear reducer, coupler, gearbox or oscillator. Alternatively, the permanent magnet may comprise a set of current loops.

The sensor also comprises a processing circuit connected to the probes 1-4 and configured to output a position signal dependent on the absolute position (excursion) of the permanent magnet A.

A magnetic position sensor C conforming to the present disclosure has a magnetization profile that follows the teachings of French Patent No. FR3118804 cited in the Background to the present disclosure. This profile is complex, resulting in multi-period variations in the magnetization profile (or its orientation relative to an axis or reference point) based on the relative trajectory of the measurement air gap and the magnet. The permanent magnet A generates a magnetic field that varies non-linearly along the movement direction, the variation presenting a form corresponding to a combination of at least two different quasi-periodic contributions.

This magnetization profile can thus be presented in a first, so-called “carried” pattern, of period p and comprising P measurement increments. It can also comprise a second, so-called “carrier” pattern, with period p*n (n real>0; constant or variable) comprising N increments. This double pattern makes it possible to combine a rough detection (global output of the sensor) and a finer detection of the absolute position (local output of the sensor). A measurement increment is, for example, constituted by the measurement of a magnetic pole. Two poles of reverse polarity will thus be able to constitute a given period of period. It is also possible to provide, in the magnetization profile, at least one magnetic anomaly leading to atypical fluxes serving as “revolution-counting” indexes making it possible to count the number of revolutions or events carried out beyond a first excursion. This output signal includes a predetermined number of T measuring increments over the measurement interval.

By way of illustration, FIG. 2 shows the three field components (radial component Br, tangential component Bt, and axial component Bz) from one of the probes 1-4 for a magnetization profile with N=2 increments on the carrier signal, and P=48 increments on the carried signal, for an angular stroke of 360° (one complete revolution). The number of magnetic anomalies T used as a “revolution-counting” index to help count the number of revolutions is taken to be zero, so as not to complicate the description of the present disclosure unnecessarily.

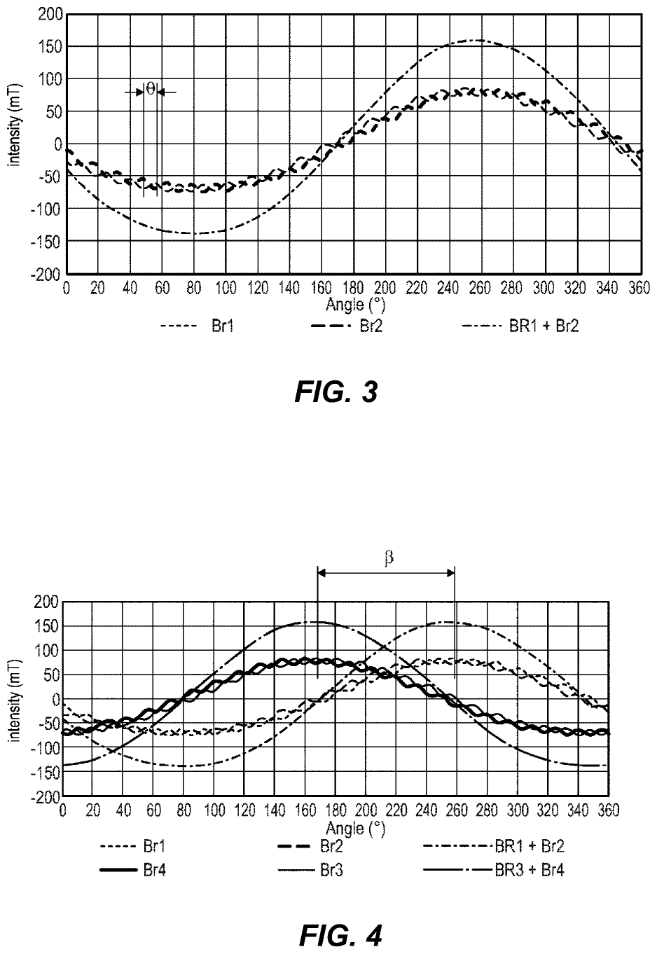

By judiciously combining the measurements made by two probes from the same pair of probes, it is noted that there is always (at least) a first angular value separating these two probes (noted theta) enabling the generation, by combining a measurement of a field component respectively produced by these two probes, of a sinusoid with a period representative of the carrier signal. This first angular value theta corresponds roughly to a half-period of the carried signal. FIG. 3 shows the result of radial field measurements Br1, Br2, respectively provided by the first main probe 1 and the second main probe 2 for a first separation angular value theta on the order of 7.5° (in this configuration P=48) of these two probes 1, 2, as well as the addition Br1+Br2 of these two signals.

By judiciously combining the measurements done by the first secondary probe 3 and the second secondary probe 4, which are phase-shifted by the same first angular value theta, it can be seen that there is always (at least) a second angular value (noted beta), respectively separating the first main probe 1 and the second main probe 2 from the first secondary probe 3 and the second secondary probe 4, making it possible to generate, by combining a measurement of a field component produced by these probes 3, 4, a second sinusoid with a period representative of the carrier signal, in quadrature with the sinusoid obtained from the first pair of probes 1, 2. This second angular value beta corresponds roughly to a quarter-period of the carrier signal.

FIG. 4 shows, for a second separation angular value beta on the order of 90° (for this configuration N=2), the result of the radial field measurements Br3, Br4, respectively provided by the probes of the second pair of probes 3, 4, as well as the addition Br3+Br4 of these two measurements.

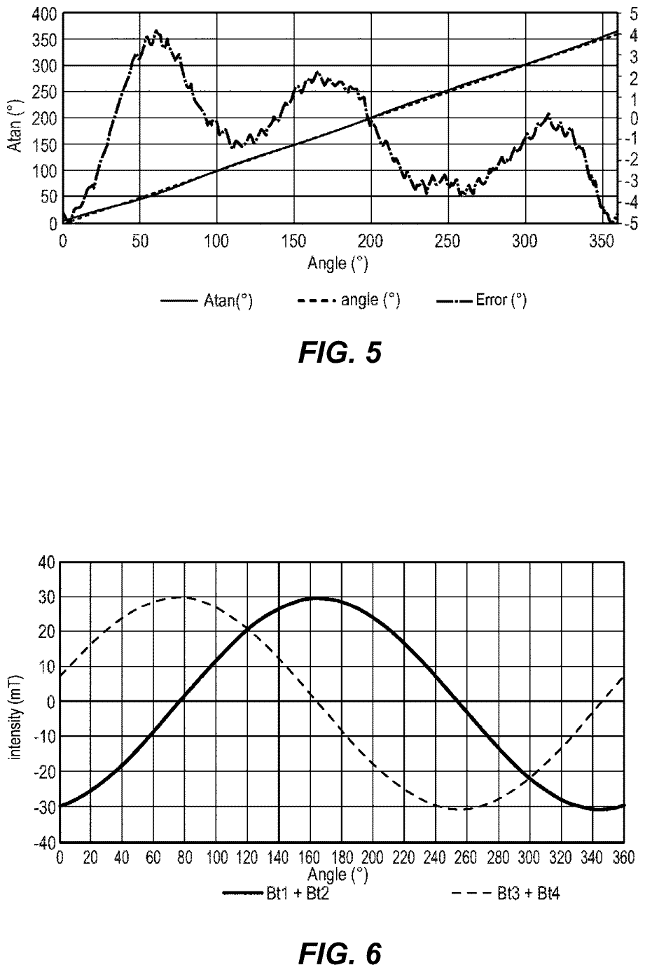

FIG. 5 shows the result of an angular position calculation provided by a sensor C with the configuration described in the present disclosure, leading to the results shown in FIG. 4. This calculation uses the arc tangent of the two sinusoids in quadrature from the measured radial components Brad, combined by addition. The angular error of the calculated global position is +/−5° over one complete revolution.

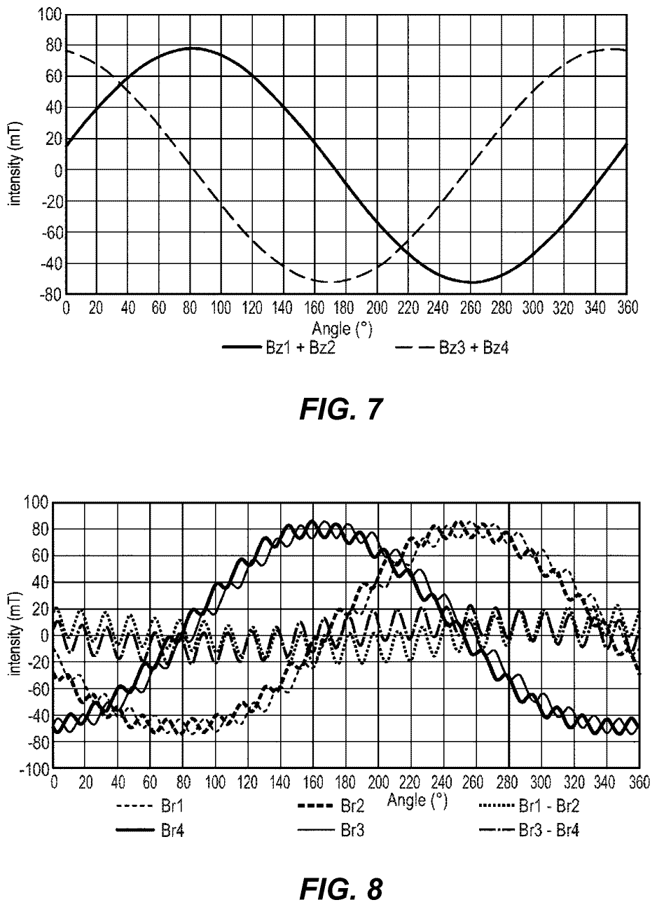

The same strategy can advantageously be applied to the tangential Bt and axial Bz components of the field, as shown in FIGS. 6 and 7, respectively. The tangential Bt and axial Bz components are combined in pairs by addition. This makes it possible to obtain three sets of curves, with similar intensities in pairs, enabling precise calculation of the overall angular value.

To calculate the local position, the same approach can be used, this time combining the field components to highlight the carried signal, in this case by subtracting the components supplied by the probes of the same pair two by two, as shown in FIG. 8.

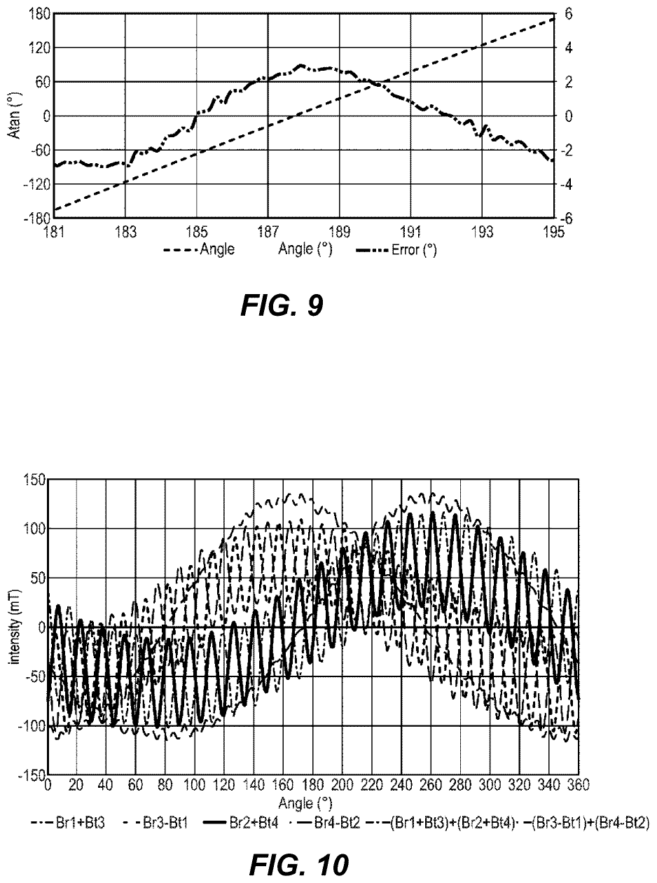

FIG. 9 thus shows the result of the angular position calculation provided by a sensor C with the configuration described in the present disclosure, leading to the results shown in FIG. 8. This calculation uses the arc tangent of the two sinusoids in quadrature from the radial components Brad. The angular error of the calculated local position is +/−3.5° over a fraction of a revolution (a pair of increments of the carried signal, that is, about 15° mechanical, in the example configuration). The angular accuracy of the mechanical angle measurement is therefore 3.5/24 pairs of increments (P=48), that is, +/−0.15°.

The same strategy can be advantageously applied to tangential components Bt and axial components Bz. It is possible to obtain three sets of curves (not shown), with similar intensities in pairs, enabling precise calculation of the local angular value.

This very general approach makes it easy to understand the advantages of differential processing of at least one of the measured field components. “Differential processing or combination” is understood to mean the combination, by difference or addition, of the field components from at least some of the probes 1-4 of the sensor C. This makes it possible to highlight the carrier signal for calculating a global angle (position in the revolution) and the carried signal for calculating a local angle (position in the increment under consideration) by way of elementary calculations.

Simultaneous calculation of both angular values guarantees instant and absolute knowledge of a precise angular (or linear) position, with no need for a minimum excursion to finalize an initial calculation.

The use of a component ratio that is exploited in tangent arc calculations ensures that the angular calculation is intrinsically insensitive to temperature variations. The components are affected in the same way, so the ratio remains unchanged.

However, the field components used previously remain sensitive to an external field. To compensate for this phenomenon, the signals provided by the probes can be combined so as to incorporate external field compensation, so that detection is insensitive to a stray external field.

With reference to FIG. 1, it is noted that:
The second main probe 2, arranged along a first axis x, measures Br2+Hx, the magnet's radial field Br2 plus the projection Hx along the first axis x of an external field Hext. Similarly, the second secondary probe 4, positioned along a second axis y, in quadrature with the axis x, measures Bt4−Hx, the tangential field Bt4 of the magnet, minus the projection Hx along the first axis x of the external field Hext. The sum of these two measurements (Br2+Hx)+(Bt4−Hx) is therefore immune to the component Hx along the first axis x of an external field. The same observation can be made by choosing the other pair of probes in quadrature 1, 3.
The second main probe 2, positioned along the first axis x, measures the magnet's tangential field Bt2+Hy, to which is added the projection Hy along the second axis y of an external field Hext. Similarly, the second secondary probe 4 arranged along the second axis y measures Br4+Hy, the radial field Br4 of the magnet, to which is also added the projection Hy along the second axis y of the external field Hext. The difference between these two measurements (Bt2+Hy)−(Br4+Hy) is therefore immune to this component Hy along the second axis y of the external field Hext. The same observation can be made by choosing the other pair of probes in quadrature 1, 3.
Finally, the second main probe 2, positioned along the first axis x, measures the magnet's axial field Bz2+Hz, to which is added the projection Hz along a third axis z (forming a trihedron with the first and second axes x, y) of an external field Hext. Similarly, the second secondary probe 4 arranged along the second axis y measures Bz4+Hz, the axial field Bz4 of the magnet, to which is also added the projection Hz along the axis z of the external field Hext. The difference between these two measurements (Bz2+Hz)−(Bz4+Hz) is therefore immune to this component Hz along the third axis z of the external field Hext.

This description is based on the assumption that the external field impinges homogeneously on all four probes. In reality, the small but inevitable distance between probes results in slight variations with no significant impact on final angular accuracy.

By combining the field components according to the formula (whose expression is simplified):
Br1+Bt3 and Br2+Bt4, and their addition;
Br3−Bt1 and Br4−Bt2, and their addition;
   it is possible to obtain robust detection of the external magnetic field for global angular position calculation, as shown in FIG. 10.

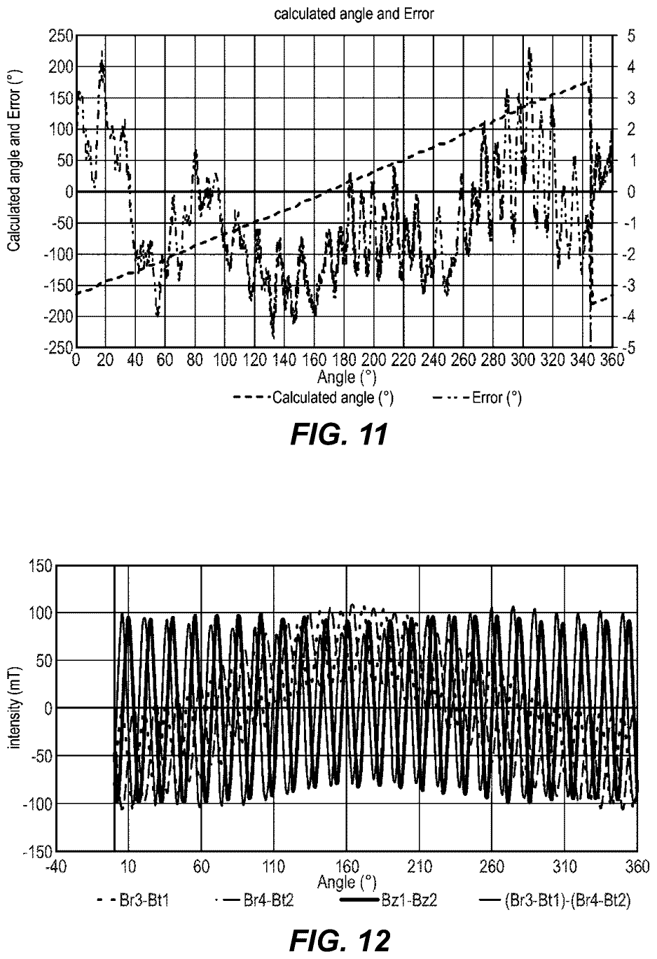

FIG. 11 shows the result of the angular position calculation provided by a sensor C implementing the combinations just presented. This calculation uses the arc tangent (or Atan2 function) of the ratio of two curves of equal intensity:
Atan2 ((Br1+Bt3)+(Br2+Bt4); Gain*((Br3−Bt1)+(Br4−Bt2))); and
the Gain value is adjusted to minimize the angular error calculated on the sensor excursion (here 0.998).

The angle measured on a complete mechanical lathe gives an angular position value of +/−5° (FIG. 11).

Advantageously, by combining the field components according to the formula (shown in FIG. 12):
Br3−Bt1 and Br4−Bt2, and their subtraction;
Bz1−Bz2;
   it is possible to obtain robust detection of the external magnetic field for local angular position calculation.

The value of the local angular position is calculated using the arc tangent (or Atan2 function) of the ratio of two curves of equal intensity:
Atan2 ((Br3−Bt1)−(Br4−Bt2); Gain*(Bz1−Bz2)); and
the Gain value is adjusted to minimize the angular error calculated on the sensor excursion (here 0.933).

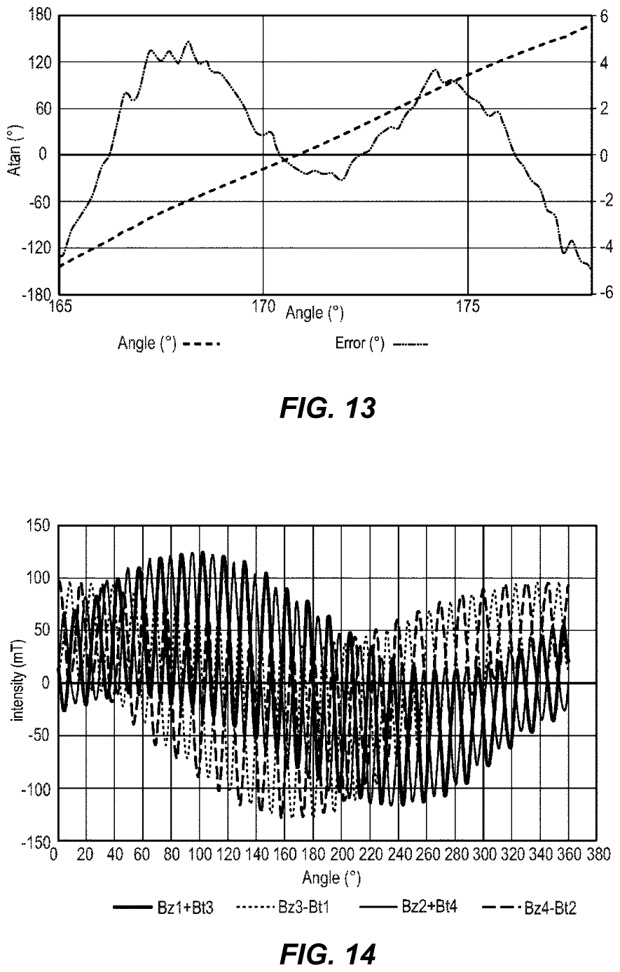

The angle calculated over one period of the carried signal (a pair of increments) gives a local angular position value of +/−5° (electrical), as shown in FIG. 13. Relative to the mechanical angle, the angular accuracy measured is 5/24=+/−0.21° mechanical over a full revolution, with the angular error measured for each incremental pair over the revolution remaining very similar.

According to a particular embodiment, shown in FIG. 14, the combination of field components according to the formula:
Bz1+Bt3 and Bz2+Bt4, and their subtraction;
Bz3−Bt1 and Bz4−Bt2, and their subtraction;
   it is possible to obtain a second detection for calculating the local angular position, with generally improved accuracy.

The value of the local angular position is calculated using the arc tangent (or Atan2) of the ratio of two curves of equal intensity:
atan2 ((Bz3−Bt1)−(Bz4−Bt2); Gain*((Bz1+Bt3)−(Bz2+Bt4))); and
the Gain value is adjusted to minimize the angular error calculated on the sensor excursion (here 0.995).

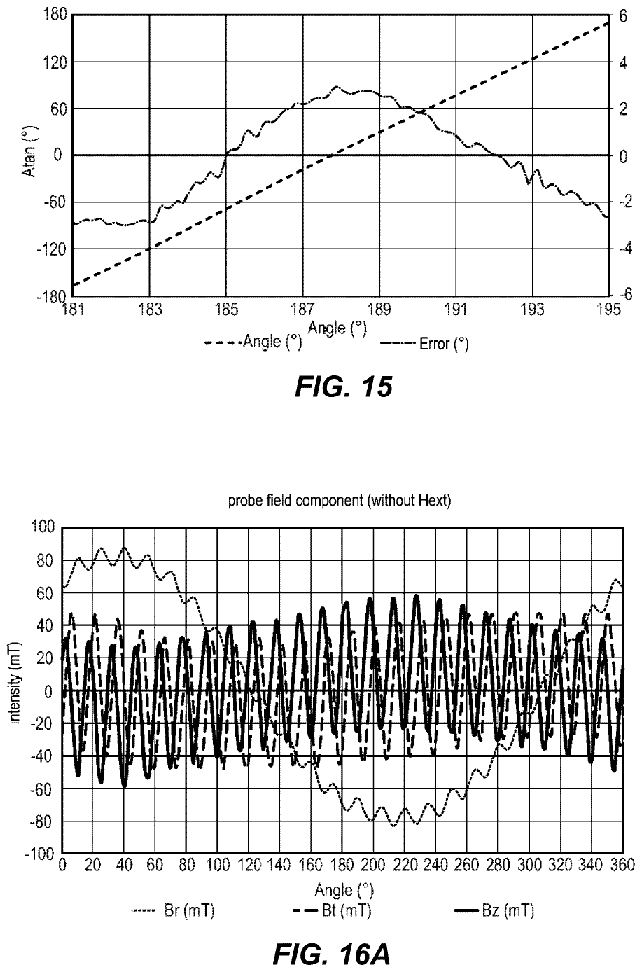

The angle calculated over one period of the carried signal (a pair of increments) gives a local angular position value of +/−3° (electrical) shown in FIG. 15. Relative to the mechanical angle, the angular accuracy measured is 3/24=+/−0.125° mechanical over a full revolution, with the angular error measured for each incremental pair over the revolution remaining very similar.

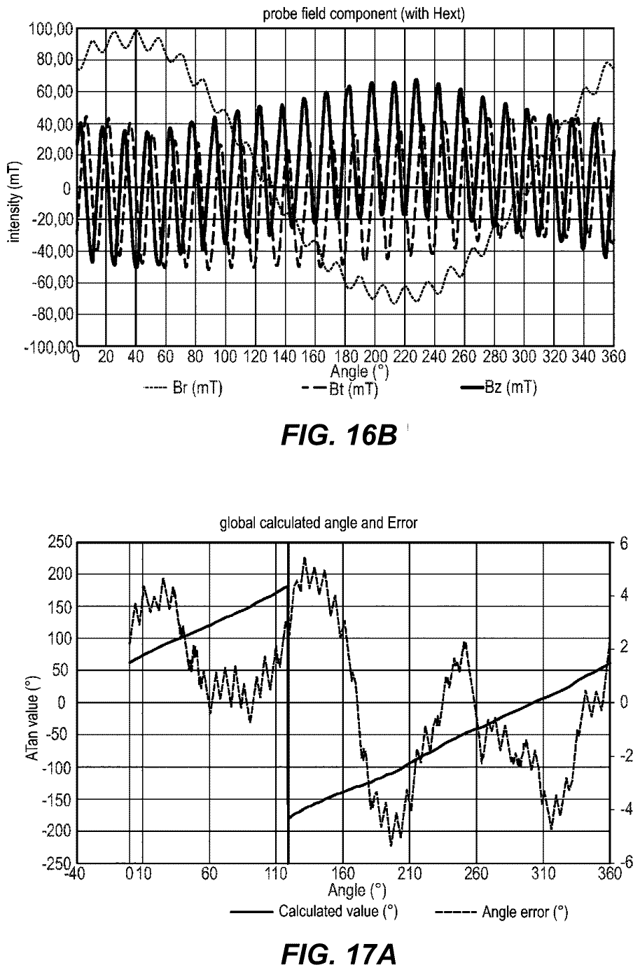

FIGS. 16A and 16B show the impact of an external magnetic field Hext (measured alone at one probe: Bx=10 mT, By=−3 mT and Bz=7 mT; homogeneous across all probes) on the field components measured (FIG. 16A) without external field Hext, (FIG. 16B) with external field Hext.

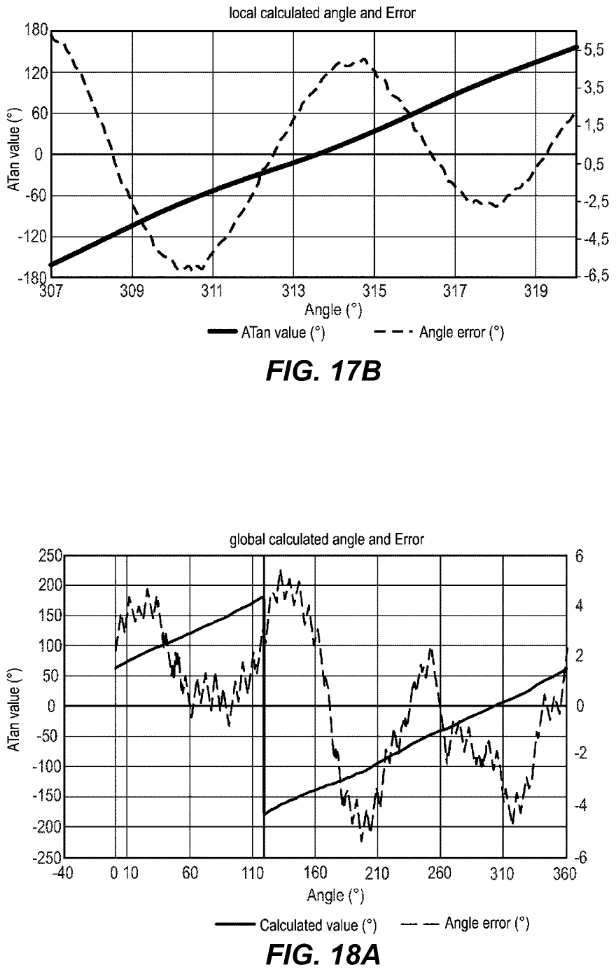

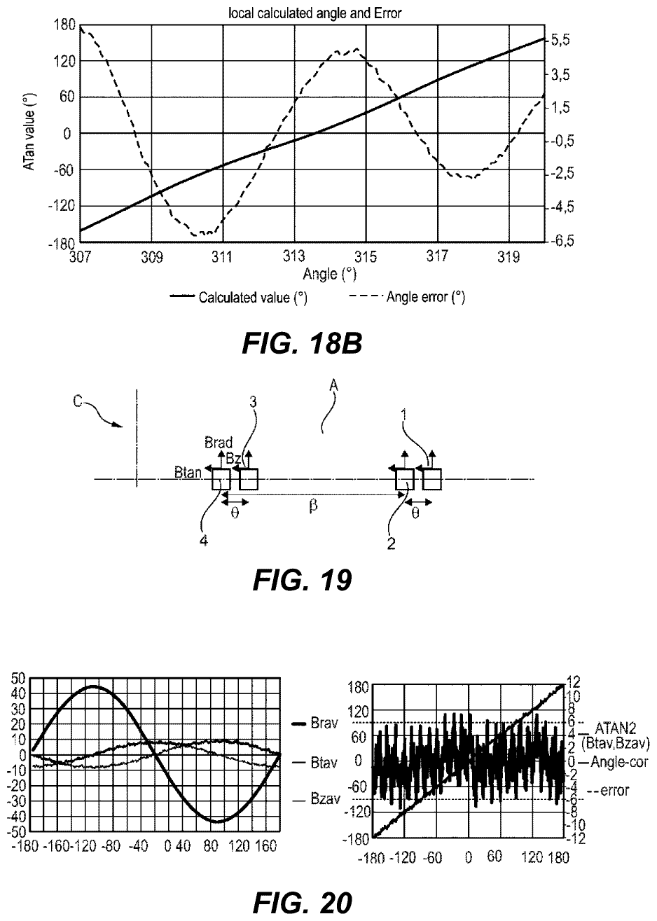

FIGS. 17A, 17B and 18A, 18B compare the angular errors calculated in the two cases.
in FIGS. 17A, 17B, in the presence of the external field Hext for (FIG. 17A) the global angular position and (FIG. 17B) the local position measured for one increment.
in FIGS. 18A, 18B, without external field Hext (FIG. 18A) for the global angular position and (FIG. 18B) for the local position measured for one increment.

As expected, the signals are unchanged. Other tested field strengths confirm these measurements.

A person skilled in the art will easily be able to tell the difference between the present disclosure and the solution proposed by prior art WO2009/101270 for calculating an angular stroke performed by radial detection on a diametrically magnetized ring for a field varying linearly with angular position. In a sensor C conforming to the present disclosure, the field measured by a magneto-sensitive element does not vary linearly with angular position. This is particularly apparent in FIG. 10. Therefore, the two approaches cannot be confused.

A sensor C according to the present description may comprise a signal processing circuit to combine the components and determine an instantaneous global and local angular value. This circuit can also perform the various compensations required to correct these angular values.

To reduce computing time, this device can combine analog and digital detection of the field components.

According to a particular embodiment, the sensor C further comprises means for storing angular values and linearity coefficients used to compensate for sensor linearity. These storage resources are accessible to the signal processing circuit, which can use them to apply processing to compensate for sensor linearity.

According to a particular embodiment, the sensor further comprises means for determining, based on the overall angular position, the facing increment or pair of increments. This increment or pair of increments is called “active.”

Each active increment is (for example) associated with a sequence number or a global angular position (identified, for example, by the zero-crossing of one of the field components or a composition of components). This method ensures, in a simple and accurate manner, that the increment read corresponds to the calculated global value, without risk of error with a neighboring increment.

Each local angular value calculated at the active increment can be used as a local angular value or full-scale percentage, or directly as a global angular value (by dividing the value read by the number of increment pairs (here 24)), and then adding it to the global angular position associated with the active increment pair: For example, 183.4° calculated in the increment corresponding to a global position (zero crossing) of 157.3° instantly gives an angular position of 157.30+183.4/24=164.94°.

Since each increment may contain magnetization anomalies, the exact angular value of each increment can be used to respect the true angular values read on the magnetic track. Thus, for a pair of increments of 15.7° (and not 15° as theoretically expected): 157.30+183.4/(360/15.7)=165.29°.

According to a particular embodiment, an angular compensation coefficient is calculated for each increment (i) according to: Increment coefficient (i)=angular value of theoretical increment/value of measured increment. This coefficient is used to correct local and/or global angular values.

According to a particular embodiment, the field component detection mode can be axial or radial, or a combination.

In a particular embodiment, the field component detection mode can be performed on different faces of the magnetic target simultaneously.

According to a particular embodiment, the sensor further comprises self-calibration means, enabling certain calculation values to be adjusted during the sensor's life to maintain an optimum level of performance.

According to a particular embodiment, the sensor further comprises diagnostic means, enabling a possible failure to be signaled (probe, magneto-sensitive element, magnetic track, communication, calculation, temperature, external field, sensor stroke, speed, etc.), and a possible degraded mode to be engaged, enabling the sensor to operate with reduced performance. In particular, this degraded mode enables detection using a minimum number of magneto-sensitive elements.

FIG. 20 gives a good indication of a global position calculation using only the signals from two theta-shifted probes (e.g., the first pair of probes 1, 2 or the second pair of probes 3, 4—left graph). The global position (graph on the right) is obtained with an Atan(Bz/Btan) calculation or an Asin(Brad) calculation, wherein Brad, Btan and Brz correspond respectively to the sum of the radial, tangential and axial field components provided by each of the two probes. The calculated linearity is +/−6° over a complete mechanical revolution.

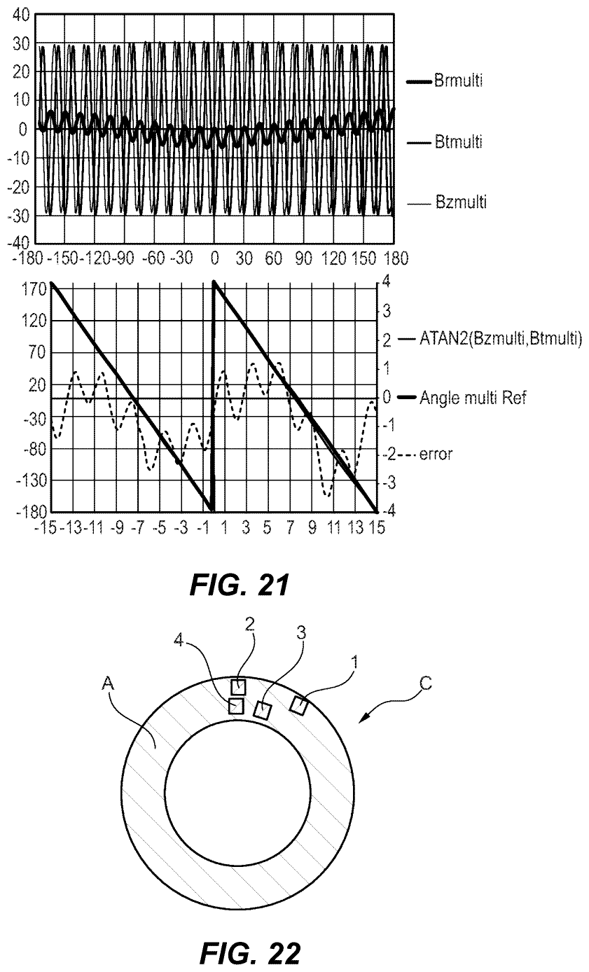

FIG. 21 gives a good indication of a local position calculation using only the signals from two probes phase-shifted by the first angular value theta. The local position is obtained with an Atan(Bz/Btan) calculation or an Asin(Brad) calculation, wherein Brad, Btan and Brz correspond respectively to the differences between the radial, tangential and axial field components provided by each of the two probes (FIG. 21). The calculated linearity is +/−3° over a pair of increments, that is, +/−0.125° or one complete mechanical revolution.

Other combinations of field components for isolating a global angular position and/or a local angular position can be selected to implement a valid detection mode according to the operating conditions envisaged.

In particular, as shown in FIG. 22:
a first pair of probes 1, 2 phase-shifted by the first angular value theta corresponding to a half-period of the carried signal. This first pair of probes 1, 2 can be used to determine a local position.
a second pair of probes 3, 4 phase-shifted by an angular value corresponding to one signal period. This second pair of probes 3, 4 can be used to determine a global position.
   the first and second probe pairs can in this case be separated by any second angular value (beta), for example, chosen to be zero.

A method for determining the precise angular position according to the calculated angular measurements will initially involve calculating the global position and the local position. In a second step, a compensated value of these angular positions can be defined. Finally, a detection diagnostic can be carried out to validate the measurement and, if necessary, initiate a degraded detection mode. The values for speed and direction of rotation are determined from the calculated angular values.

According to a particular embodiment, a mathematical function (such as a polynomial) can be used to compensate for angular value (or linear excursion) calculations. Each increment will be associated with the set of coefficients required to define this function (6 coefficients for a polynomial of order 5) and a combination of functions.

According to a particular embodiment, a trigonometric function (or its equivalent) can be used to compensate for angular value (or linear excursion) calculations. Each increment will be associated with the set of coefficients required to define that function (e.g., Intensity, period, angular offset), and a combination of functions.

According to a particular embodiment, the sensor may use only a very small number of magneto-sensitive elements capable of measuring one or more field components, or any combination, to meet space or price requirements. This solution could also be envisaged for detection over very limited strokes (<360° for a rotary sensor).

In another variant, the measuring device can include a plurality of probes, each arranged at a specific point, enabling the operating mode to be doubled or tripled. By averaging all the values obtained by all these probes, it is possible to obtain an averaged angular value that reduces the uncertainty associated with a single set of probes (e.g., a set of four probes capable of measuring one or more field components). The use of 5, 6, 7 or 8 probes can thus be envisaged, for example, to create a fully redundant sensor for applications requiring maximum integrity and dependability (ASIL D type for automotive applications). This can also be used to enrich the combination of different field components.

Of course, the present disclosure is not limited to the embodiment described and variant embodiments can be added thereto without departing from the scope of the present disclosure as defined by the claims.

In this way, the sensor C can take on a linear configuration as shown FIG. 19. This linear configuration can be obtained by mentally unfolding a solution obtained for axial or radial angular detection. Since the field profiles of the various field components are similar, processing remains identical, taking care to position the sets of magneto-sensitive element correctly (linearly spaced) to obtain valid first and second angular values beta and theta for differential analysis.

Whether the sensor C is linear or disk-shaped, the sets of magneto-sensitive element can be repositioned relative to the permanent magnet, so that the first angular value theta and/or the second angular value beta can be adjusted.

The sensor can be used to measure quantities in addition to angular or linear displacement in a complex system. This magnitude may correspond to a force, torque, acceleration, braking, phase shift, overall speed, movement direction, distance, number of revolutions, inertia, imbalance, vibration, noise, harmonic content, temperature, pressure, electrical current, electrical voltage, electrical current, frequency, information encoding.

1.-16. (canceled)

17. A non-contact angular or linear magnetic position sensor, comprising:
a permanent magnet generating a magnetic field that varies non-linearly in a movement direction, the variation comprising, in various field components, a combination of at least one first quasi-periodic carried signal and at least one second quasi-periodic carrier signal, the at least one first quasi-periodic carried signal and the at least one second quasi-periodic carrier signal being different from one another;
at least one first pair of probes comprising a first main probe and a first secondary probe, the first pair of probes being associated with the permanent magnet and each of the first pair of probes being capable of measuring at least two field components at a single point; and
a processing circuit connected to the at least one first pair of probes and configured to exploit at least some of measurements provided by the at least one first pair of probes and to deliver a position signal representative of an absolute position of the permanent magnet;
wherein the first main probe and the first secondary probe are positioned with respect to one another so as to enable a first quasi-periodic signal representative of a global position and a second quasi-periodic signal representative of a local position to be isolated by differential combination of field component measurements.

18. The non-contact magnetic position sensor of claim 17, further comprising a second pair of probes comprising a second main probe and a second secondary probe, the second pair of probes being associated with the permanent magnet and each probe of the second pair of probes being capable of measuring at least two field components at the same point, the two pairs of probes being positioned relative to one another so as to obtain quadrature matching obtained from the signals by differential combination.

19. The non-contact magnetic position sensor of claim 18, wherein the processing circuit establishes:
the measurement of the global position of the sensor by combining the field components according to the formula: Atan2 ((Br1+Bt3)+(Br2+Bt4); Gain*((Br3−Bt1)+(Br4−Bt2))); or
the measurement of the local position of the sensor by combining the field components according to the formula: Atan2 ((Br3−Bt1)−(Br4−Bt2); Gain*(Bz1−Bz2)),
wherein Bri, Bti and Bzi respectively represent the radial, tangential and axial field measured by a probe of index i and wherein Gain is a quantity chosen so as to minimize an angular error calculated on the excursion of the sensor.

20. The non-contact magnetic position sensor of claim 18, wherein the processing circuit establishes the measurement of the local position of the sensor by combining the field components according to the formula: Atan2((Bz3−Bt1)−(Bz4−Bt2); Gain*((Bz1+Bt3)−(Bz2+Bt4))), wherein Bri, Bti and Bzi respectively represent the radial, tangential and axial field measured by a probe of index i and wherein Gain is a quantity chosen so as to minimize an angular error calculated on the excursion of the sensor.

21. The non-contact magnetic position sensor of claim 17, wherein the permanent magnet is a multipole magnet or a magnet assembly or an equivalent machined magnet.

22. The non-contact magnetic position sensor of claim 17, wherein the permanent magnet comprises a set of current loops.

23. The non-contact magnetic position sensor of claim 17, wherein the permanent magnet comprises at least a portion of a rotor of an electric motor, generator, actuator, gear reducer, coupler, gearbox or oscillator.

24. The non-contact magnetic position sensor of claim 17, wherein each probe comprises a plurality of magneto-sensitive elements selected from among the group consisting of a Hall probe, a magnetoresistive element, an eddy-current element, and a detection coil.

25. The non-contact magnetic position sensor of claim 17, wherein the permanent magnet has a shape of a disk, ring or cylinder, and the probes of the at least one first pair of probes are arranged on a periphery of the magnet.

26. The non-contact magnetic position sensor of claim 17, wherein the processing circuit is configured to use an angular compensation factor to correct calculated angular values.

27. The non-contact magnetic position sensor of claim 26, wherein the correction of the calculated angular values is based on trigonometric functions.

28. The non-contact magnetic position sensor of claim 26, wherein the processing circuit is configured to combine analog and digital detection of the field components.

29. The non-contact magnetic position sensor of claim 17, wherein the processing circuit establishes the global position measurement and/or local position measurement on different faces of the permanent magnet simultaneously.

30. The non-contact magnetic position sensor of claim 17, wherein the probes of the at least one first pair of probes are separated by a first angular value corresponding to a half-period of the carried signal.

31. The non-contact magnetic position sensor of claim 18, wherein the probes of the first pair of probes and the probes of the second pair of probes are respectively separated from one another by a second angular value substantially equal to a quarter period of the at least one second quasi-periodic carrier signal.

32. The non-contact magnetic position sensor of claim 31, wherein the first angular value and/or the second angular value is adjustable.

33. A method comprising providing a non-contact magnetic position sensor according to claim 17 and measuring at least one value on a system using the sensor, the value relating to at least one of force, torque, acceleration, braking, phase shift, overall speed, movement direction, distance, number of revolutions, inertia, imbalance, vibration, noise, harmonic content, temperature, pressure, electrical current, electrical voltage, electrical current, frequency, or information encoding.
